(19) United States
(12) Patent Application Publication
(10) Pub. No.: US 2008/0215405 A1
(43) Pub. Date: Sep. 4, 2008

(54) COMPONENT BASED APPLICATIONS RUNNING IN A COMMON SHELL

(75) Inventors: Erik Roser Dibbern, Denmark (DK); Ricky Kaare Rasmussen, Denmark (DK); Laurent Lopez, Denmark (DK); Bjarne Schon, Denmark (DK)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/680,686

(22) Filed: Mar. 1, 2007

(51) Int. Cl. G06F 9/46

(52) U.S. Cl. 705/8

(57) ABSTRACT

Applications are provided in as usable and intuitive tasks or subtasks that can be integrated with business solutions. The tasks or subtasks can be reutilized in a code or definition of the application, mitigating the amount of code and memory needed to be installed on a user device. In addition, the tasks or subtasks can be utilized across applications, further conserving device resources. The user can be presented with the tasks or subtasks in a logical flow or progression, allowing for ease of completion of the tasks.

### BACKGROUND

Computing devices are commonly utilized by users to communicate almost instantaneously with one or more contacts. Such information exchange can occur by an user entering information (e.g., text, visual, audio, and so on) into a display area of an user device and communicating with the one or more contacts in a back-and-forth manner without using a telephone or other method of communication. This almost instantaneous communication allows a user and various contacts in disparate locations to communicate in a real time fashion.

As computing devices become prevalent in the business world, companies are realizing the benefit of providing the work force access to its business solution through these devices. This enables the services and information of a business solution to be readily available from a device, improves productivity and reduces expenses. However, these systems contain a tremendous amount of information and functionality and, therefore, the needed amount of computing space can become quite large, which can be a heavy load for some devices. Thus, providing the work force with all the information and functionality of a business may complicate matters and filtering through the information becomes time consuming. Thus, workers should be given only the information and functionality needed to adequately perform the task.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with a mobile framework that can be scaled and customized to create role-based, task-oriented applications. The applications are provided as usable and intuitive applications that can be integrated with business solutions.

In accordance with some embodiments, provided is customization for an individual user, customer, role and so forth, by breaking down complexity by componentizing the application into blocks or subsets. These componentized blocks or subsets can be reusable in other applications. The flow between the blocks or subsets can be handled through an orchestration, which can specify order, when the transaction can occur and/or a mapping of state between the blocks or the subsets.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system for creating role-based, task oriented applications.

FIG. 2 illustrates an exemplary device displaying blocks of an application that can be presented to a user.

FIG. 3 illustrates a system for scaling and customizing role based task-oriented applications in accordance with the disclosed embodiments.

FIG. 4 illustrates an exemplary orchestration in accordance with the embodiments disclosed herein.

FIG. 5 illustrates an exemplary assembly of a subset of a task.

FIG. 6 illustrates an example of a blocks and a sample code in accordance with one or more embodiment disclosed herein.

FIG. 7 illustrates an exemplary code for adding a new tasklet to an orchestration.

FIG. 8 illustrates adding orchestrations to build an application in accordance with the various embodiments.

FIG. 9 illustrates another system for creating role-based, task oriented applications.

FIG. 10 illustrates a screen shot of an exemplary tasklet user interface.

FIG. 11 illustrates a method for providing tasks in a logical implementation format.

FIG. 12 illustrates a block diagram of a computer operable to execute the disclosed embodiments.

FIG. 13 illustrates a schematic block diagram of an exemplary computing environment operable to execute the disclosed embodiments.

### DETAILED DESCRIPTION

Various embodiments are now described with reference to the drawings. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various embodiments disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

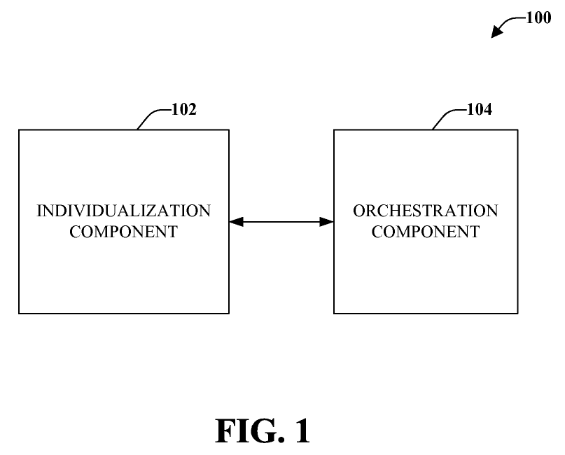

Referring initially to FIG. 1, illustrated is a system 100 for creating role-based, task oriented applications. System 100 can be configured to customize an application without the device (or user of the device) on which the application is installed having knowledge of the architecture and complete backend business solution. Work performed on a device is usually task-oriented and specific to the person using the device. For example, a sales person places orders and checks pricing. A person working in the shipping department views orders and signs-off on shipments. Therefore, system 100 can provide an interface that is customized to match the role of the user.

In further detail, system 100 includes a individualization component 102 that can be configured to break a business solution up into smaller parts, which can be referred to as blocks, sub-portion, subcomponent, subset (of an application) or a “tasklet” (e.g., a little or small portion of a task) throughout this detailed description. Individualization component 102 can be configured to develop each block of the business solution as a separate assembly. These blocks can be reusable in the same or a different application/business solution and can represent a single dialog page and/or function. Breaking down the complexity of a business solution into these blocks can enable easy to configure and implement customer/user/role specific flows.

An orchestration component 104 interfaces with the individualization component 102 to piece the blocks together into different configurations. This gathering of blocks can create a personalized, role-based application that can be installed on a device-by-device basis. For example, one device might be for a worker that gathers water meter readings at customers' houses and another worker might service water pipelines in the event a water pipeline breaks. Each worker can be provided different blocks and/or flows relating to the water company services. The first worker can be provided the flow relating to the water meters that are to be read that day and a means for capturing the information and submitting it to the main facility. The second worker can be provided a flow relating to the location of the pipeline needing maintenance, the type of maintenance needed and a means for entering the work performed, the hours worked, the supplies used and so forth.

Some customized mobile applications are created by developing separate applications for each scenario and then loading the applications into the devices. These methods utilize a tremendous amount of storage space on the device and generally provided the worker with more information than was needed or desired. System 100 provides a streamlined approach of providing a user with information as well as a simple and understandable format for the user to carry out the desired task or application. Thus, system 100 mitigates the amount of storage or memory used on the device as well as a simple, easy to implement task or application.

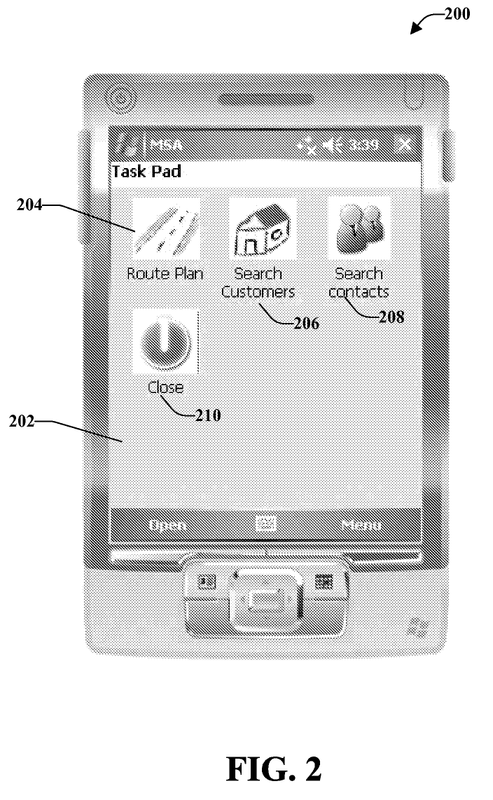

FIG. 2 illustrates an exemplary device 200 displaying blocks of an application that can be presented to a user. A block is an assembly of code, such as managed code and/or any type of executable code, that can be configured to perform a specific action. These blocks can represent a specific task (e.g., a single step in a larger procedure) that should be performed by the device user to carry out at least a portion of a business solution. For example, a block can display a list of customers or details of a specific customer.

The blocks can be integrated into a user interface of the device 200. Such integration can offer a similar look and user experience between devices even if the tasks performed by respective users of the devices are different. The blocks can be configured to extend a number of common components and can add new components to provide a comprehensive programming model. A programming code or combination of programming codes (e.g. C# programming, XML, and so on) can be utilized to build customized, role-based applications.

An interface or display area 202 can contain representations of the blocks as applications that can include a series of intuitive, menu-driven screens that the user can navigate to view information and exchange data with the backend business solution (not shown). The blocks can be included in a single display area 202, which can be referred to as a “TaskPad” or by another name to indicate the various tasks that a user can implement and navigate with the device 200.

The display area 202 can be designed to produce customized mobile applications that can minimize programming through the reuse of code (e.g., blocks). This re-utilization can mitigate the amount of code and/or memory needed to be installed on a user device. In addition, the tasks or subtasks can be utilized across applications, further conserving device resources. For example, when a worker places an order, the order processing involves a few steps, such as choosing the items, entering shipping information and sending the order. When a “Taskpad” application is developed, each of these steps can be developed as a separate block or subset of the application.

As illustrated in FIG. 2, common tasks can be provided and individualized for the device user. This device has applications, illustrated as icons or visual representations of the corresponding task. These applications include a “Route Plan” 204, which, if selected, can provide the user with a recommended plan of action or the order of steps that should be taken (e.g., the order that water meters should be read for the day). Another application can include “Search Customers” 206 and/or “Search Contacts” 208, which can provide a simple to use manner for the user to search for these various items. Another icon the user can choice can be “Close” application 210, which can be used at the end of the workday or when the user desires to power off the device. A user can choose a desired action 204, 206, 208, 210, with a pointing device, a stylus, or verbally speaking the action or through various other means of interfacing with the device 200. It should be understood that the application illustrated and described are merely examples and a multitude of other applications can be provided to the device user.

The display area (or an interface component) 202 can provide a graphical user interface (GUI), a command line interface, a speech interface, Natural Language text interface, and the like. For example, a GUI can be rendered that provides a user with a region or means to load, import, select, read, etc. the one or more pieces of a business solution and can include a region to present the results of such (e.g., display component). These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed. For example, the user can interact with the one or more pieces of business solution or compilation thereof by entering the information into an edit control.

The user can also interact with the regions to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed embodiments are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

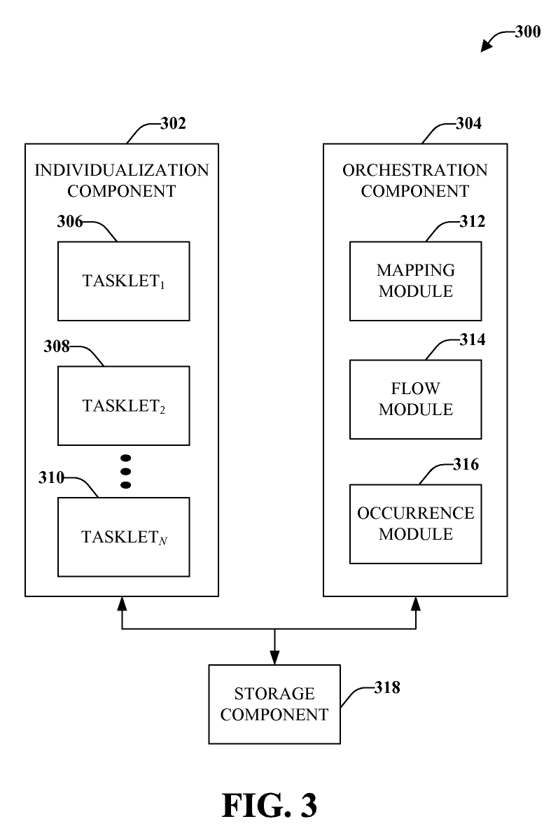

With reference now to FIG. 3, illustrated is a system 300 for scaling and customizing role based, task-oriented applications in accordance with the disclosed embodiments. System 300 can include an individualization component 302 and an orchestration component 304. The individualization component 302 can be configured to divide a business solution or task into individual pieces (e.g., blocks, subsets, “tasklet”). There can be a multitude of blocks available for a given task or business solutions as illustrated by Tasklet₁ 306, Tasklet₂ 308, and Tasklet_{N} 310, where N is an integer greater than or equal to one. A block (e.g., “tasklet”) is an assembly of managed code that performs a specific action and is generally a single step in a larger procedure (e.g., task, business solution, procedure, and so forth). Blocks can be configured to extract data from a database or information formatted in another manner, to accept input from another block, to output data, or to obtain/send information to other places, components, or combinations thereof.

The orchestration component 304 can be configured to selectively control the flow and interactions between various blocks. Included in orchestration component 304 can be a mapping module 312 that can be configured to map the various actions or flows to a particular block of data included in individualization component 302.

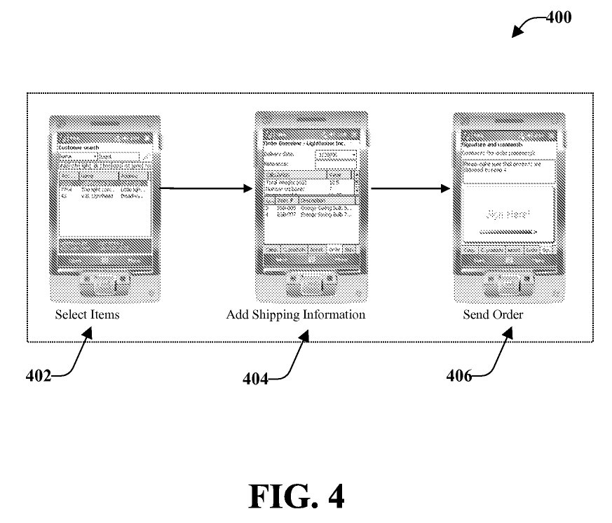

Also included in orchestration component 304 can be a flow module 314 that can be configured to organize the various blocks needed for an application into a logical and understandable flow. An exemplary flow 400, which can be designed by flow module 314, is illustrated with reference to FIG. 4. Three blocks or subsets of an application are illustrated. The first block “select items” 402 flows logically into the second block “add shipping information” 404. Thus, a user placing an order would first select the items desired to be purchased and, once all selections are made, shipping information can be entered so that the user can receive the product. The next block “send order” 406 is a logical next step to finish processing of the order.

Thus, flow module 304 can design a flow as “A” to “B” to “C”. If another step is found to be needed, such as a step “D” or a step between “A”, “B”, or “C”, flow module 314 can re-configure the flow to allow such steps to be added (e.g., scaling). The flow can be added dynamically by a user or other entity. For example, a user can interface with system 300 to easily add, delete or modify steps as needed. In some embodiments, a service provider can perform the desired configuration and submit the new orchestration to the device 300, such as through an Internet connection or other means of shipping the product (e.g., code) to the customer or installing the information on the system 300.

With continuing reference to orchestration component 304, is an occurrence module 316 that can be configured to reuse a block 306, 308, 310 within the same application and/or across applications. In such a manner, occurrence module 316 mitigates the amount of storage space needed to implement the disclosed techniques. Occurrence module 316 also can facilitate ease of compiling and running the code.

The various blocks 306, 308, 310 can be maintained in a database or library. A storage component 318 can be associated with individualization component 302 and/or orchestration component. Information contained in storage component 318 can include, but is not limited to, the application, blocks defining the application, other applications, a business solution, user information, device information, or other information.

By way of example, and not limitation, storage component 318 can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of example and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

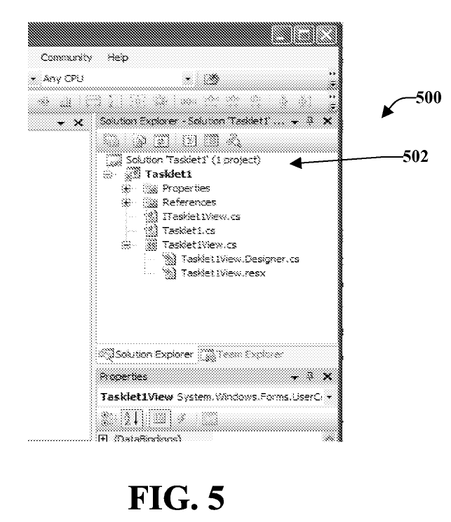

With reference now to FIG. 5, illustrated is an exemplary assembly of a subset of a task 500. In some embodiments, the task subset can be created utilizing a hierarchical process. For example, a task can be defined, such as “Solution ‘Tasklet1’ (1 project) 502. From this task, portions of the task can be defined, such as properties or references associated with the task or portion of the task. In such a manner, a designer, user or other entity can simply define various parameters of a task that can be utilized numerous times within a single task or across tasks or applications.

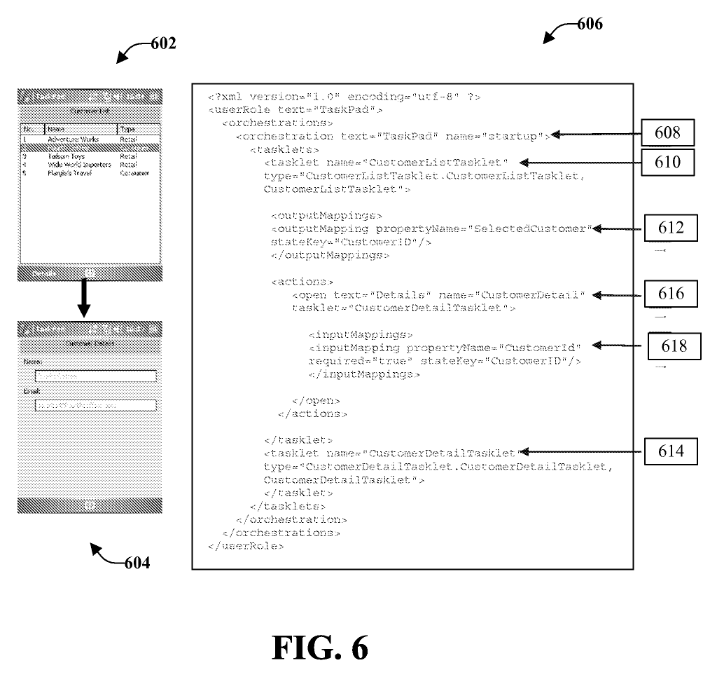

FIG. 6 illustrates an example of blocks 602, 604, as displayed to a user, and a sample code 606 in accordance with one or more embodiment disclosed herein. It should be understood that while the sample code shown an illustrated is in XML file, other techniques can be utilized and all such techniques are intended to fall within the scope of this detailed description.

An <orchestration> element 608 can be utilized to define the orchestration, which can specify a relation between one or more blocks, subsets of a task, or a “tasklet”. In the example illustrated, there is one orchestration, however, there can be a number of orchestrations depending on the task or business solution. For example, this code could also include an orchestration for adding a new customer, for placing order, and so on. Each of these added tasks can be defined in its own orchestration.

A <tasklet name=““type=””> 610 can declare a block based on its fully qualified type name. Each block (e.g., tasklet) should be declared in an orchestration. As illustrated, the first tasklet listed in the first <orchestration> element 608 of the UserRole is the tasklet that opens when the application is initiated. Therefore, in this example, the Customer List Tasklet is placed first. A tasklet can be used in more than one orchestration with a UserRole.xml, for example. The name attributes allows a user to reference the declaration from another location in the orchestration. Thus, the tasklet is declared once for simplicity and can be utilized in other portions of the orchestration without being declared a second time.

The Customer List Tasklet can output an ID to identify the selected customer. An <outputMapping> element 612 can be utilized to transfer this ID to a Customer Details Tasklet 614. An <actions> element 616 can specify actions a user can take from a tasklet screen. This element 616 can determine the menu soft-keys and menu items and which tasklet the menu items and menu soft-keys link.

In this example, the Customer List Tasklet is to be linked to the Customer Details Tasklet from a Details soft key. To implement this, an <open text=“Details” name=“CustomerDetail” tasklet=“CustomerDetailTasklet”>, where text=“Details” specifies the button text and tasklet=“CustomerDetailTasklet” calls the Customer Details Tasklet declared earlier. To display data from a specific customer in the Customer Details Tasklet an <input> element 618 can be added to map the customer ID output from the Customer List Tasklet to the Customer Details Tasklet.

Once the Tasklets are defined, the application can be extended (e.g., scaling) or modified without modifying the code. This allows a user to easily adapt an application to fit a particular need, task or business solution. The user can perceive blocks 602, 604 rather than having to read and understand the code, which might be input by another user and/or entity.

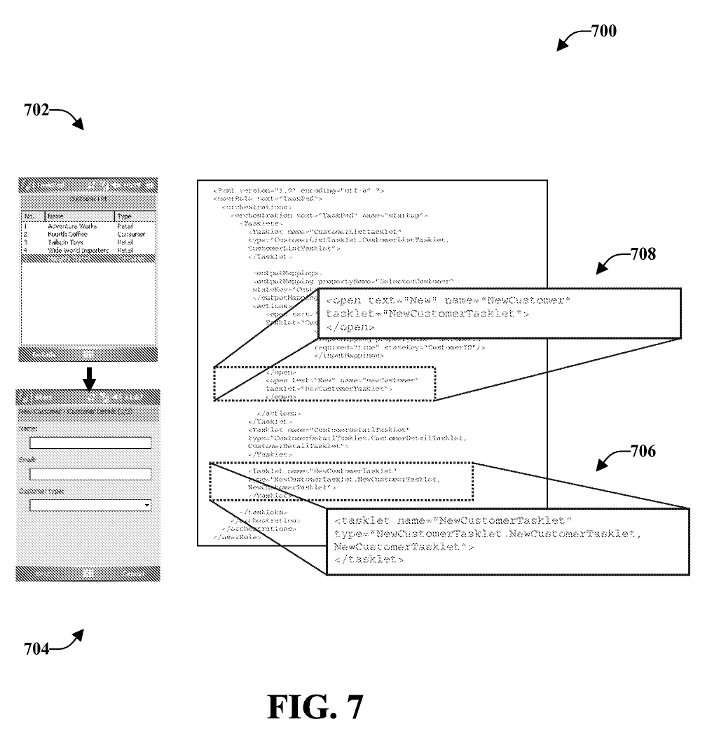

FIG. 7 illustrates an exemplary code 700 for adding a new tasklet to an orchestration. This is similar to the code 600 in the above figure, however, now a tasklet is to be included for adding a new customer from the Customer List. In this example, the Tasklet is called NewCustomerTasklet 706. To perform the modification in the application, a user simply changes the Orchestration to include a line that declares the Create New Customer Tasklet 706 and an action to open the Tasklet 708 from a menu item called New. In such a manner, the task can be easily modified if it is determined that changes need to be made to improve and perform the desired action(s). The user would perceive the blocks 702 and 704, which are based on the information included in the code 700.

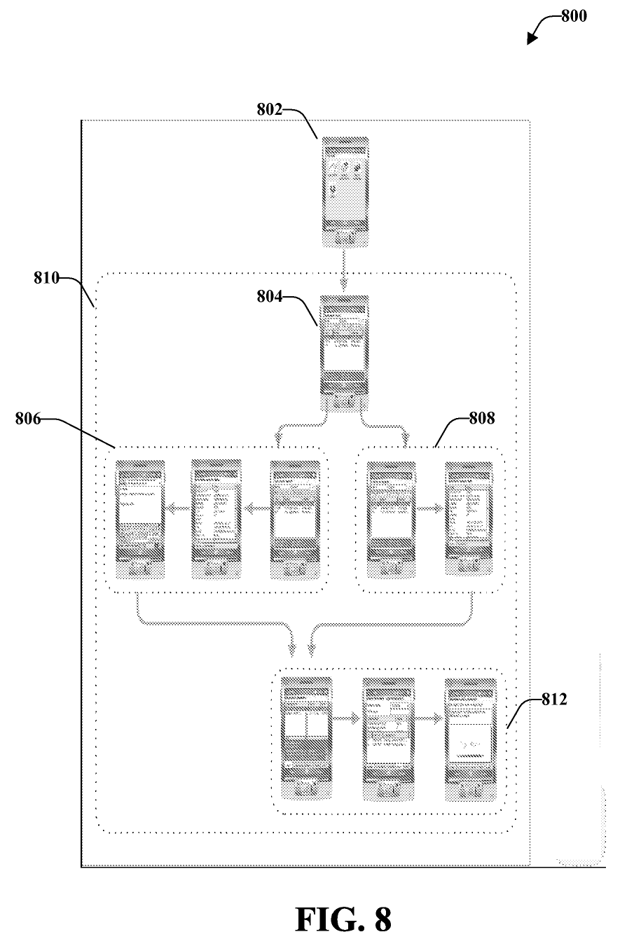

FIG. 8 illustrates an orchestration 800 to build an application in accordance with the various embodiments. The orchestration 800 can be referred to as a flow diagram or list of tasks that should be completed to accomplish the business solution. A first block 802 can be presented to the user. This block 802 can be similar to the block shown and described with reference to FIG. 2. At substantially the same time as a user selects one of the tasks in the first block 802, the flow moves to the next block 804.

The flow moves through subsequent blocks, depending on a user selection. For example, if the customer selects the task “Add Customer” from the second block 804, the orchestration 806 is invoked, which can step the customer through a series of tasks. If however, the user selects “Customer Details” from the second block 804, the orchestration 808 is invoked, which can include different or similar tasks as the first orchestration 806. The group of blocks that include the second block 804, and the orchestrations 806 and 808 can be considered an orchestration 810. The flow can continue with a subsequent orchestration 812, such as “Place Order” that can include a number of blocks (or tasklets) as needed to place the order and step the though the entire task.

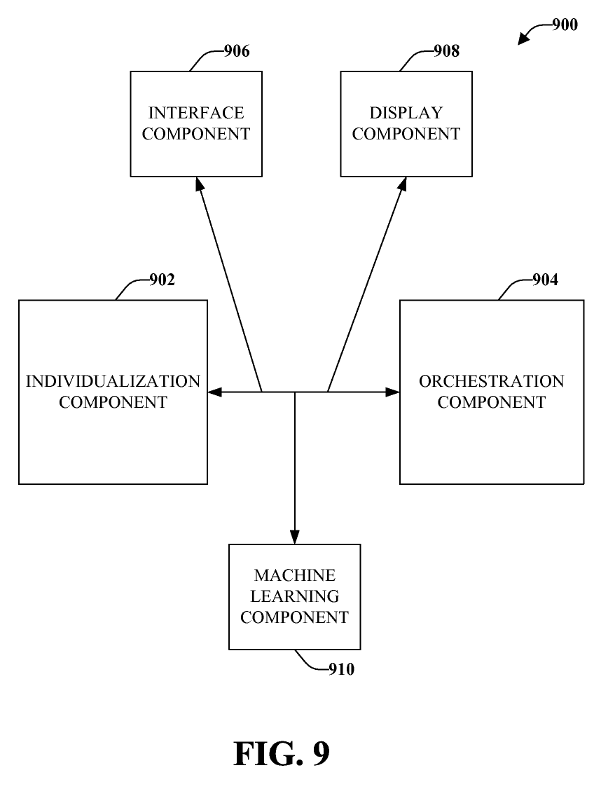

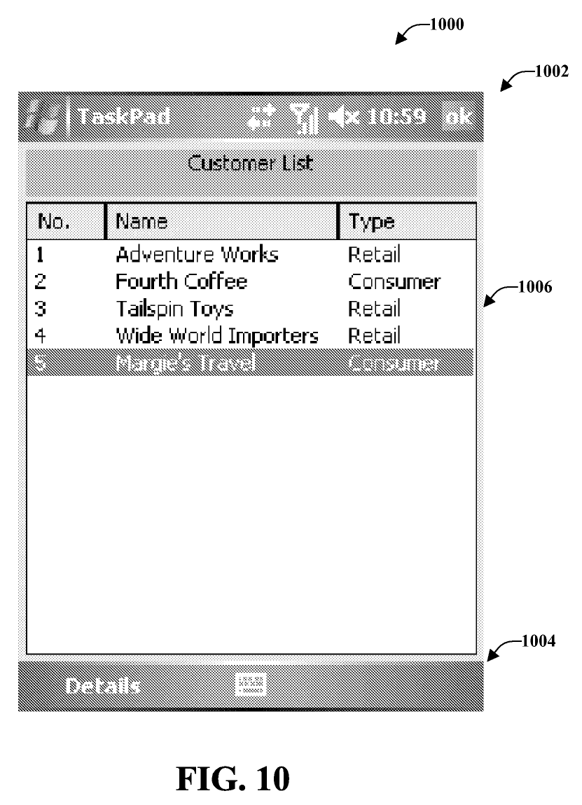

FIG. 9 illustrates another system 900 for creating role-based, task oriented applications. System 900 includes an individualization component 902 that can be configured develop each part of the business solution as a separate assembly. Also included in system 900 is an orchestration component 904 that can be configured to combine each part of a business solution together into different configurations. An interface component 906 can be configured to allow a user, developer, or other individual and/or entity to modify the various parts of the business solution to create and/or modify each part and/or to combine the parts in a different format. Interface component 906 can also be configured to allow the user to interact with the business solution to perform tasks. Such business solutions, tasks and other items can be presented to the user, such as through display component 908. For example, the display component 908 can present a flow and interaction between the various blocks or subsets in a readily perceivable and understandable format. Various formats include a visual representation, an audible representation or combinations thereof. Further information regarding the interface component 906 and the display component 908 will be provided with reference to FIG. 10.

In some embodiments, system 900 can include a machine-learning component 910 that can be configured to facilitate automating one or more features in accordance with the one or more embodiments. The AI can be effected by AI component 1202 as illustrated. The various embodiments (e.g., in connection with individualizing the various components of a business solution) can employ various machine learning schemes (e.g., Artificial Intelligence (AI), rules-based logic, and so forth) for carrying out various aspects thereof. For example, a process for determining if a particular component has applicability to a particular business solution or if a particular resource requires another component to carry out the business solution can be facilitated through an automatic classifier system and process. Moreover, where multiple business solutions are employed having the same or similar resources, the classifier can be employed to determine which components to employ in a particular situation.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of business solution systems, for example, attributes can be tasks or actions or other data-specific attributes derived from the tasks (e.g., key words, the presence of key terms), and the classes are categories or areas of interest (e.g., levels of priorities, order of implementing the solution).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more embodiments can employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria when to grant access, which stored procedure to execute, etc. The criteria can include, but is not limited to, the amount of data or resources to accessed through a call, the type of data, the importance of the data, etc.

Artificial intelligence based systems (e.g., explicitly and/or implicitly trained classifiers) can be employed in connection with performing inference and/or probabilistic determinations and/or statistical-based determinations as in accordance with one or more aspects as described hereinafter. As used herein, the term “inference” refers generally to the process of reasoning about or inferring states of the system, environment, and/or user from a set of observations as captured through events, sensors, and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject embodiments.

FIG. 10 illustrates a screen shot of an exemplary user interface 1000. An user interface 1000 can display information on the device screen. In some embodiments, the information is provided though an audible means or through other means that can be perceived by the user. A template can be provided that includes a navigation bar 1002 and soft-key menus 1004. This provides the user with an easily perceivable and understandable format (e.g., by a display component). In such a manner, the blocks or tasklets 1006 for each user can appear similar and the difference can be in the content and the layout specific to that particular tasklet.

In view of the exemplary systems shown and described above, methods that may be implemented in accordance with the disclosed subject matter, will be better appreciated with reference to the following flow charts and throughout this detailed description. While, for purposes of simplicity of explanation, the methods can be shown and described as a series of blocks, it is to be understood and appreciated that the disclosed embodiments are not limited by the number or order of blocks, as some blocks may occur in different orders and/or concurrently with other blocks from what is depicted and described herein. Moreover, not all illustrated blocks may be required to implement the methods described hereinafter. It is to be appreciated that the functionality associated with the blocks may be implemented by software, hardware, a combination thereof or any other suitable means (e.g. device, system, process, component). Additionally, it should be further appreciated that the methods disclosed hereinafter and throughout this specification are capable of being stored on an article of manufacture to facilitate transporting and transferring such methods to various devices. Those skilled in the art will understand and appreciate that a methodology could alternatively be represented as a series of interrelated states or events, such as in a state diagram.

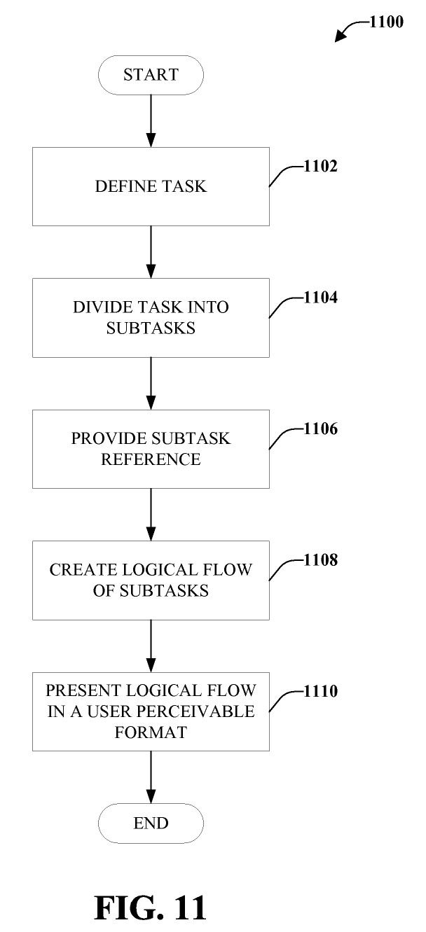

FIG. 11 illustrates a method 1100 for providing tasks in a logical implementation format. Method 1100 starts, at 1102, when a task is defined. The task can be a job to be performed, a project, a business solution, or other items that can be completed in a logical flow. The defined task can be divided into subtasks or subsets of the task, at 1104. These subtasks can be logical steps within the task that are completed in order to complete the entire task. For example, if the defined task is to “Wash Dishes”, logical subtasks might be: (1) fill sink with soapy hot water; (2) submerge item in water; (3) clean item with dishtowel and soapy hot water; (4) rinse item in clean water; (5) place item in dish rack; (6) dry item with clean, dry cloth; (7) repeat from step (1).

At 1106, a reference for each subtask can be provided. This reference can be a name (e.g., (1) Fill_Sink; (2) Submerge; (3) Clean, and so forth). Naming or providing another reference to the subtask can allow such subtask to be easily utilized in other portions of the same task, if needed, or across tasks. For example, if another task is defined as “Wash Glasses”, then the subtasks (or a subset thereof) can be utilized for new, different task.

The subtasks are put into a logical flow, at 1108, such as the flow described above with reference to washing the dishes. For example, a block associated with the defined task can be places with other blocks associated with the task and/or with one or more blocks obtained from a different defined flow. This logical flow should easily step the user though the subtasks in a logical manner to mitigate the about of rework, unnecessary steps, or redundant steps. The logical flow can be presented to the user in a perceivable format, at 1110. This format can be in the form of a display on a user interface (e.g., visual representation), as described with reference to the above figures. The format may also be audible instructions (e.g., audible representation) or another perceivable means. Thus, the user is provided a customized, role-based flow that is broken down into easily completed subtasks that can facilitate timely completion of a task, project, or business solution or a portion thereof.

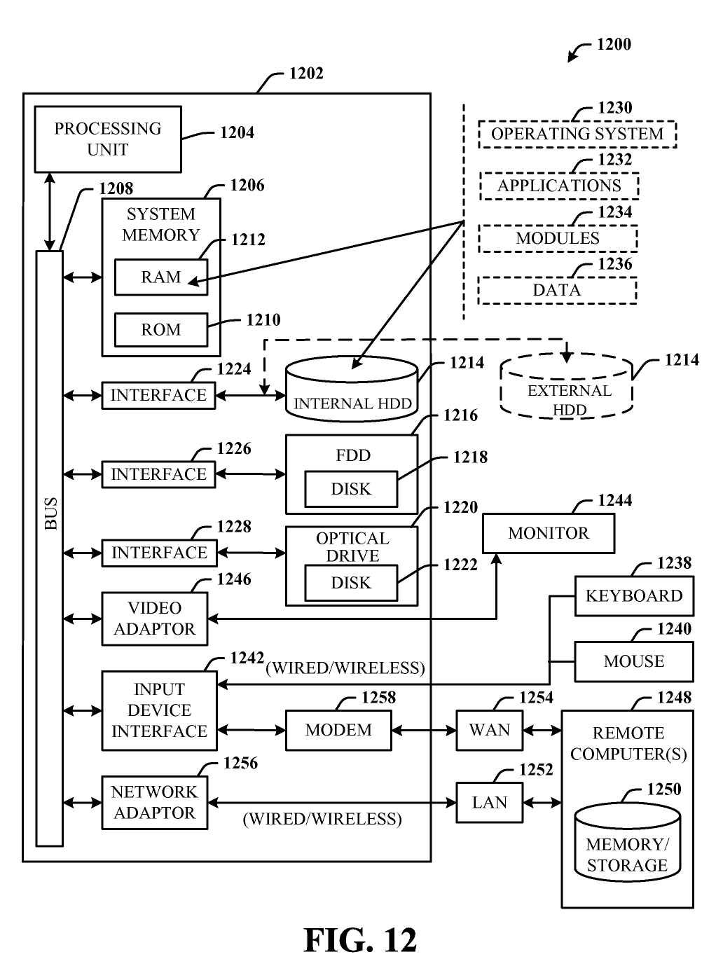

Referring now to FIG. 12, there is illustrated a block diagram of a computer operable to execute the disclosed architecture. In order to provide additional context for various aspects disclosed herein, FIG. 12 and the following discussion are intended to provide a brief, general description of a suitable computing environment 1200 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the various embodiments can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 through an interface, such as a video adapter 1246. In addition to the monitor 1244, a computer typically includes other peripheral output devices (not shown), such as speakers, printers, etc.

The computer 1202 may operate in a networked environment using logical connections through wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adaptor 1256 may facilitate wired or wireless communication to the LAN 1252, which may also include a wireless access point disposed thereon for communicating with the wireless adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 through the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

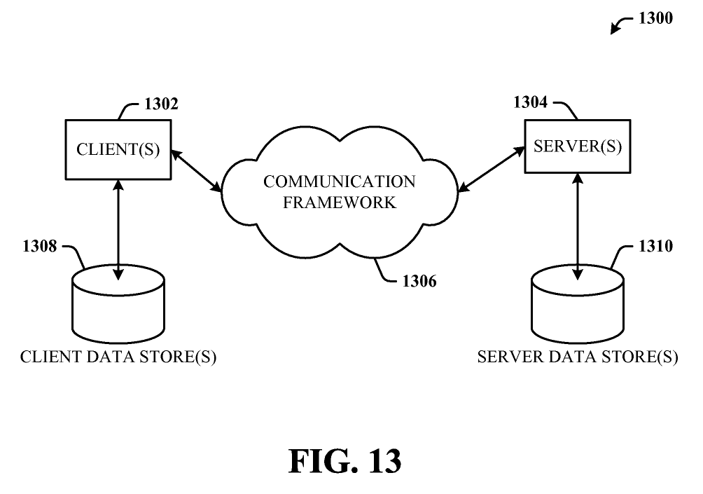

Referring now to FIG. 13, there is illustrated a schematic block diagram of an exemplary computing environment 1300 in accordance with the various embodiments. The system 1300 includes one or more client(s) 1302. The client(s) 1302 can be hardware and/or software (e.g., threads, processes, computing devices). The client(s) 1302 can house cookie(s) and/or associated contextual information by employing the various embodiments, for example.

The system 1300 also includes one or more server(s) 1304. The server(s) 1304 can also be hardware and/or software (e.g., threads, processes, computing devices). The servers 1304 can house threads to perform transformations by employing the various embodiments, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated through a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

What is claimed is:

1. A system for scaling and customizing role based, task-oriented applications, comprising:
an individualization component that divides a business solution into at least two subtasks; and
an orchestration component that selectively controls the flow and interactions between the at least two subtasks to complete a task-oriented application.

2. The system of claim 1, further comprising a display component that presents the flow and interactions between the at least two subtasks in a readily perceivable and understandable format

3. The system of claim 2, the display component provides a visual representation, an audible representation or combinations thereof.

4. The system of claim 1, further comprising a mapping module that maps the at least two subtasks to respective blocks of data.

5. The system of claim 4, further comprising a flow module that organizes the blocks of data into a logical flow.

6. The system of claim 1, further comprising a flow module that provides scaling by adding at least a third subtask into the flow.

7. The system of claim 1, further comprising an occurrence module that reuses the at least two subtasks within the task-oriented application or within a second application.

8. The system of claim 1, further comprising a storage component that maintains the at least two subtasks in a database.

9. The system of claim 1, further comprising an interface component that allows a user to modify the business solution or the at least two subtasks.

10. The system of claim 1, further comprising an interface component that provides the user a means to interact with the business solution to complete the task-oriented application.

11. The system of claim 1, the subtasks can extract data from a database, accept input from another subset, or output data or combinations thereof.

12. The system of claim 1, further comprising a machine-learning component that automatics one or more component of system.

13. A method for providing tasks in a logical implementation format, comprising:
dividing a defined task into at least one block that comprises a subset of the defined task;
providing a reference for the at least one block;
placing the at least one block with at least a second block in a logical flow; and
presenting the logical flow to a user.

14. The method of claim 13, dividing the defined task into the at least one block comprises items that can be completed in a logical flow.

15. The method of claim 13, providing a reference for the at least one block comprises assigning a name to the block.

16. The method of claim 13, placing the at least one block with at least a second block comprises obtaining the at least a second block from a second defined task.

17. The method of claim 13, placing the at least one block with the at least a second block in a logical flow comprises stepping the user through the blocks in a logical manner.

18. The method of claim 13, presenting the logical flow to a user comprises producing a visual representation or an audible representation or both the visual representation and the audible representation.

19. A computer executable system that provides customizing task-oriented applications, comprising:
means for partitioning an application into a subset of tasks;
means for organizing the subset of tasks into a flow diagram; and
means for presenting the flow diagram to a user for completion of the subset of tasks.

20. The computer executable system of claim 19, further comprising means for allowing modification of the application or the subset of tasks or both the application and the subset of tasks.
